(19) United States
(12) Patent Application Publication
(10) Pub. No.: US 2025/0313255 A1
(43) Pub. Date: Oct. 9, 2025

(54) MODULAR STROLLER

(71) Applicants: Stephon Wilkerson, Greensboro, NC (US); Eboni Wilkerson, Greensboro, NC (US)

(72) Inventors: Stephon Wilkerson, Greensboro, NC (US); Eboni Wilkerson, Greensboro, NC (US)

(21) Appl. No.: 19/170,161

(22) Filed: Apr. 4, 2025

Related U.S. Application Data
(60) Provisional application No. 63/574,941, filed on Apr. 5, 2024.

(51) Int. Cl. B62B 7/10; A45F 3/04; A45F 3/08; B62B 7/08; B62B 7/14; B62B 9/14; B62B 9/20; B62B 9/26

(52) U.S. Cl. CPC B62B 7/10; A45F 3/08; B62B 7/08; B62B 7/142; B62B 9/142; B62B 9/20; B62B 9/26; A45F 2003/045

(57) ABSTRACT

A modular stroller for reducing a traveler's burden. The modular stroller includes a collapsible frame and moves between an expanded configuration and a stored configuration. In the expanded configuration, the modular stroller is usable as a stroller for transporting an infant while also carrying a backpack and a car seat. In the stored position, the modular stroller is contained in a backpack.

### CROSS-REFERENCE TO RELATED APPLICATIONS

This application claims the benefit and priority to U.S. Provisional Patent Application No. 63/574,491, filed on Apr. 5, 2024, the contents of which are herein incorporated by reference in its entirety.

### BACKGROUND

Traveling with infants and young children is difficult. Parents have to transport the infant, a stroller, a carrying apparatus, a seat, and various supplies for taking care of the infant (e.g., diaper bag). This is particularly troublesome when traveling via airplanes and similar types of transportation. Parents must transport their children, check in the stroller, carry a supplies bag, and their own luggage. Further, when leaving the airport, it can be difficult to find a vehicle that fits all of the luggage and supports the car seat. Therefore, there is a need for a modular stroller that reduces a parent's burden when traveling with an infant/child.

### FIELD OF THE DISCLOSURE

The present disclosure is generally related to modular strollers, more specifically to modular strollers that convert to a storage apparatus to improve traveling.

### DESCRIPTION OF RELATED ART

Existing strollers include collapsible strollers and strollers with removable seats. However, existing strollers fail to provide a modular solution that enables a stroller to reduce into a compact size to lower a traveler's burden. These existing strollers provide adjustable components, but do not provide a comprehensive product that is operable to sufficiently reduce its size. Therefore, there is a need for a modular stroller that provides an all-in-one solution for improving travel with infants and children.

### BRIEF SUMMARY

In some embodiments, the present disclosure includes a modular stroller designed to move between a backpack, a car seat configuration, and a stroller. The modular stroller is designed to fit inside the backpack. Advantageously, this provides effortless portability and storage when worn on the user's back.

In at least one aspect of the present disclosure, a modular stroller frame is disclosed. The modular stroller frame can include at least one support brace, a plurality of support members, a base, and a plurality of wheels. The at least one support brace can be adjustably connected to the plurality of support members. The modular stroller frame can move between a collapsed configuration and an open configuration. When moving from the collapsed configuration to the open configuration, the at least one support brace can move away from the plurality of support members.

In at least one aspect of the present disclosure, the at least one support brace is U- shaped. In at least one aspect of the present disclosure, the plurality of wheels can be adjustably connected to the plurality of support members. In at least one aspect of the present disclosure, the at least one support brace can be adjustably connected to the plurality of support members via at least one adjustably component. The support brace can slide along a track of the adjustable component. In at least one aspect of the present disclosure, the at least one support brace can include at least one extension component. The at least one extension component can adjust a position of the at least one support brace. In at least one aspect of the present disclosure, each support member of the plurality of support members can receive an attachment component corresponding to the base. In at least one aspect of the present disclosure, the base can releasably engage a seat.

In at least one aspect of the present disclosure, a modular stroller frame is disclosed. The modular stroller frame can include at least one support brace, a plurality of support members, a base, and a plurality of wheels. The at least one support brace can be adjustably connected to the plurality of support members. The base can be adjustably connected to the plurality of support members. The modular stroller frame can move between a collapsed configuration and an open configuration. When moving from the collapsed configuration to the open configuration, the at least one support brace can move away from the plurality of support members.

In at least one aspect of the present disclosure, the at least one support brace is U-shaped. In at least one aspect of the present disclosure, the plurality of wheels can be adjustably connected to the plurality of support members. In at least one aspect of the present disclosure, the at least one support brace is adjustably connected to the plurality of support members via at least one adjustable component. Theat least one support brace can slide along a track of the adjustable component. In at least one aspect of the present disclosure, the at least one support brace includes at least one extension component. The at least one extension component can adjust a position of the at least one support brace. In at least one aspect of the present disclosure, the modular stroller frame can further include a storage container. In the collapsed configuration, the at least one support brace, the plurality of support members, and the plurality of wheels can be positioned inside the storage container. In at least one aspect of the present disclosure, the storage container includes a backpack.

In at least one aspect of the present disclosure, the modular stroller frame includes at least one support brace, a plurality of support members, a base, and a plurality of wheels. The at least one support brace can be adjustably connected to the plurality of support members. The base can be adjustably connected to the plurality of support members. The plurality of wheels can be adjustably connected to the plurality of support members. The modular stroller frame can move between a collapsed configuration and an open configuration. When moving from the collapsed configuration to the open configuration, the at least one support brace can move away from the plurality of support members.

In at least one aspect of the present disclosure, the at least one support brace can include at least one extension component. The at least one support brace can adjust a position of the at least one support brace. In at least one aspect of the present disclosure, the modular stroller frame can include a storage container. When in the collapsed configuration, the at least one support brace, the plurality of support members, and the plurality of wheels can be positioned inside the storage container. In at least one aspect of the present disclosure, the at least one support brace is U-shaped. In at least one aspect of the present disclosure, the at least one support brace is adjustably connected to the plurality of support members via at least two adjustable connectors. The at least two adjustable connectors can include at least one of a hinged joint, a telescoping joint, a ball-and-socket joint, a swivel joint, a sliding joint, a pivot joint, a latching joint, and/or a locking joint. In at least one aspect of the present disclosure, the base can receive a seat via at least one attachment component. The at least one attachment component can include a latch, a hook and loop fastener, and/or a harness.

### BRIEF DESCRIPTION OF THE DRAWINGS

The embodiments illustrated, described, and discussed herein are illustrative of the present disclosure. As these embodiments of the present disclosure are described with reference to illustrations, various modifications, or adaptations of the methods and or specific structures described may become apparent to those skilled in the art. It will be appreciated that modifications and variations are covered by the above teachings and within the scope of the appended claims without departing from the spirit and intended scope thereof. All such modifications, adaptations, or variations that rely upon the teachings of the present disclosure, and through which these teachings have advanced the art, are considered to be within the spirit and scope of the present disclosure. Hence, these descriptions and drawings should not be considered in a limiting sense, as it is understood that the present disclosure is in no way limited to only the embodiments illustrated.

FIG. 1A illustrates a top perspective view of a modular stroller frame according to at least one aspect of the present disclosure.

FIG. 1B illustrates a side view of the modular stroller frame shown in FIG. 1A.

FIG. 1C illustrates a front view of the modular stroller frame shown in FIG. 1A.

FIG. 1D illustrates a top view of the modular stroller frame shown in FIG. 1A.

FIG. 2A illustrates a front perspective view of a modular stroller frame according to at least one aspect of the present disclosure.

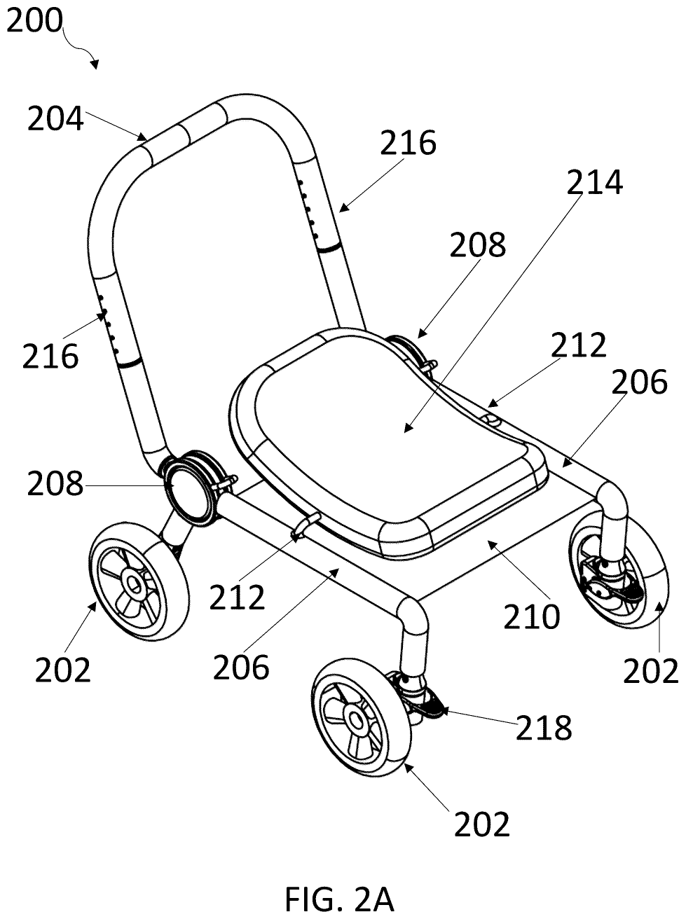

FIG. 2B illustrates a side view of the modular stroller frame shown in FIG. 2A.

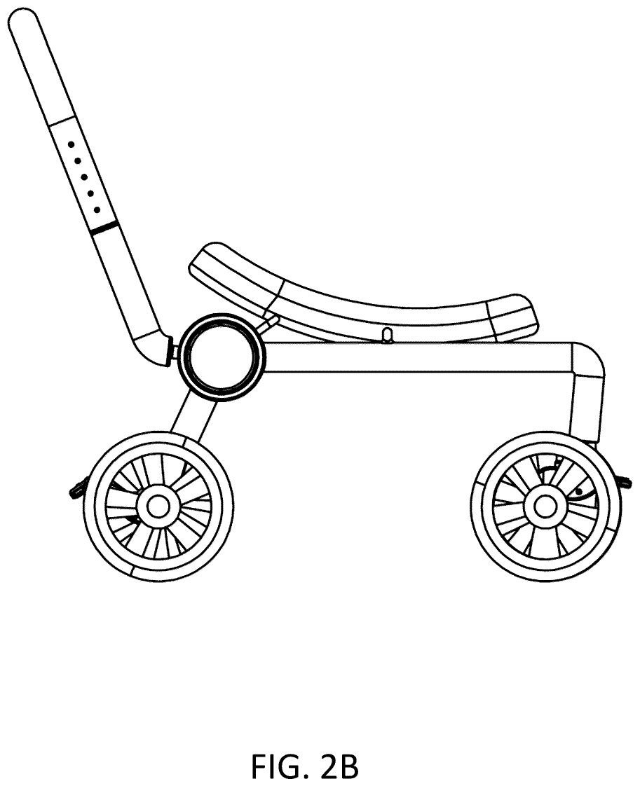

FIG. 2C illustrates a front view of the modular stroller frame shown in FIG. 2A.

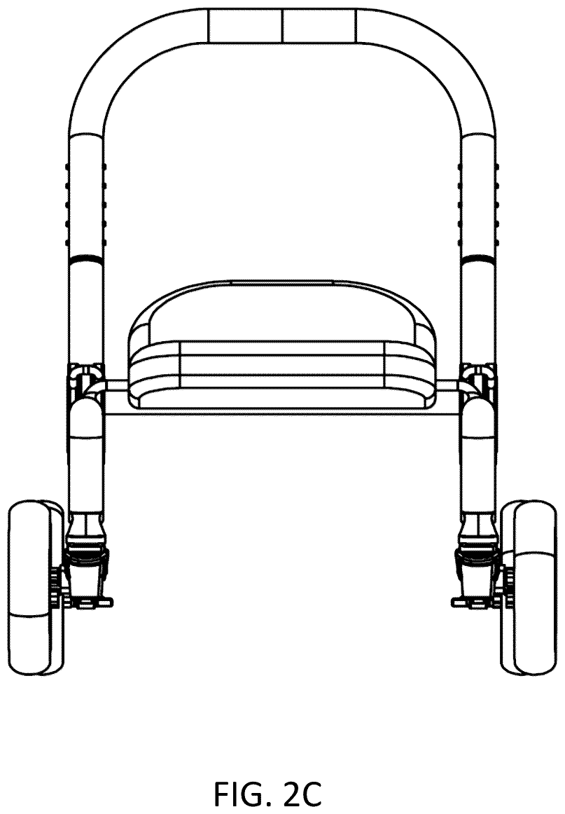

FIG. 2D illustrates a top view of the modular stroller frame shown in FIG. 2A.

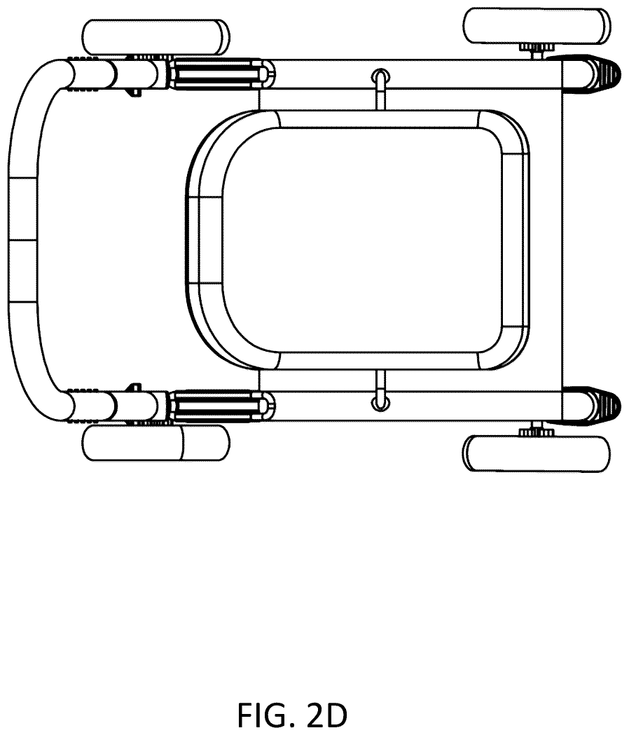

FIG. 3A illustrates a perspective view of a modular stroller frame according to at least one aspect of the present disclosure.

FIG. 3B illustrates a side view of the modular stroller frame shown in FIG. 3A.

FIG. 3C illustrates a front view of the modular stroller frame shown in FIG. 3A.

FIG. 3D illustrates a top view of the modular stroller frame shown in FIG. 3A.

FIG. 4A illustrates a side perspective view of a modular stroller according to at least one embodiment of the present disclosure.

FIG. 4B illustrates a side perspective view of the modular stroller as shown in FIG. 4A.

FIG. 4C illustrates a rear perspective view of the modular stroller as shown in FIG. 4A.

FIG. 4D illustrates a front perspective view of the modular stroller as shown in FIG. 4A.

FIG. 5A illustrates a side view of a modular stroller according to one embodiment of the present disclosure.

FIG. 5B illustrates a top view of the modular stroller shown in FIG. 5A.

FIG. 5C illustrates a rear view of the modular stroller shown in FIG. 5A.

FIG. 6A illustrates a side perspective view of a modular stroller in a backpack according to one embodiment of the present disclosure.

FIG. 6B illustrates a side perspective view of the modular stroller stored in the backpack shown in FIG. 6A.

FIG. 6C illustrates a side perspective view of the modular stroller stored in the backpack shown in FIG. 6A.

FIG. 6D illustrates a rear perspective view of the modular stroller stored in the backpack shown in FIG. 6A.

FIG. 6E illustrates a front perspective view of the modular stroller stored in the backpack shown in FIG. 6A.

FIG. 7A illustrates a side perspective view of a frame of a modular stroller according to one embodiment of the present disclosure.

FIG. 7B illustrates a side perspective view of the frame of a modular stroller shown in FIG. 7A.

### DETAILED DESCRIPTION

For the purpose of promoting an understanding of the present disclosure, reference will be made to preferred embodiments and specific language will be used to describe the same. It will nevertheless be understood that no limitation of the scope of the disclosure is thereby intended, such alteration and further modifications of the disclosure as illustrated herein, being contemplated as would normally occur to one skilled in the art to which the disclosure relates.

Articles “a” and “an” are used herein to refer to one or to more than one (i.e., at least one) of the grammatical object of the article. By way of example, “a composite” means at least one composite and can include more than one composite.

Throughout the specification, the terms “about” and/or “approximately” may be used in conjunction with numerical values and/or ranges. The term “about” is understood to mean those values near to a recited value. For example, “about 40 [units]” may mean within +/−25% of 40 (e.g., from 30 to 50), within +/−20%, +/−15%, +/−10%, +/−9%, +/−8%, +/−7%, +/−6%, +/−5%, +/−4%, +/−3%, +/−2%, +/−1%, less than +/−1%, or any other value or range of values therein or there below. Furthermore, the phrases “less than about [a value]” or “greater than about [a value]” should be understood in view of the definition of the term “about” provided herein. The terms “about” and “approximately” may be used interchangeably.

As used herein, the verb “comprise” as is used in this description and in the claims and its conjugations are used in its non-limiting sense to mean that items following the word are included, but items not specifically mentioned are not excluded.

Throughout the specification the word “comprising,” or variations such as “comprises” or “comprising,” will be understood to imply the inclusion of a stated element, integer or step, or group of elements, integers, or steps, but not the exclusion of any other element, integer or step, or group of elements, integers, or steps. The present disclosure may suitably “comprise”, “consist of”, or “consist essentially of”, the steps, elements, and/or reagents described in the claims.

It is further noted that the claims may be drafted to exclude any optional element. As such, this statement is intended to serve as antecedent basis for use of such exclusive terminology as “solely”, “only”, and the like in connection with the recitation of claim elements, or the use of a “negative” limitation.

Unless defined otherwise, all technical and scientific terms used herein have the same meanings as commonly understood by one of ordinary skill in the art to which this disclosure belongs. Preferred methods, devices, and materials are described, although any methods and materials similar or equivalent to those described herein can be used in the practice or testing of the present disclosure. All references cited herein are incorporated by reference in their entirety.

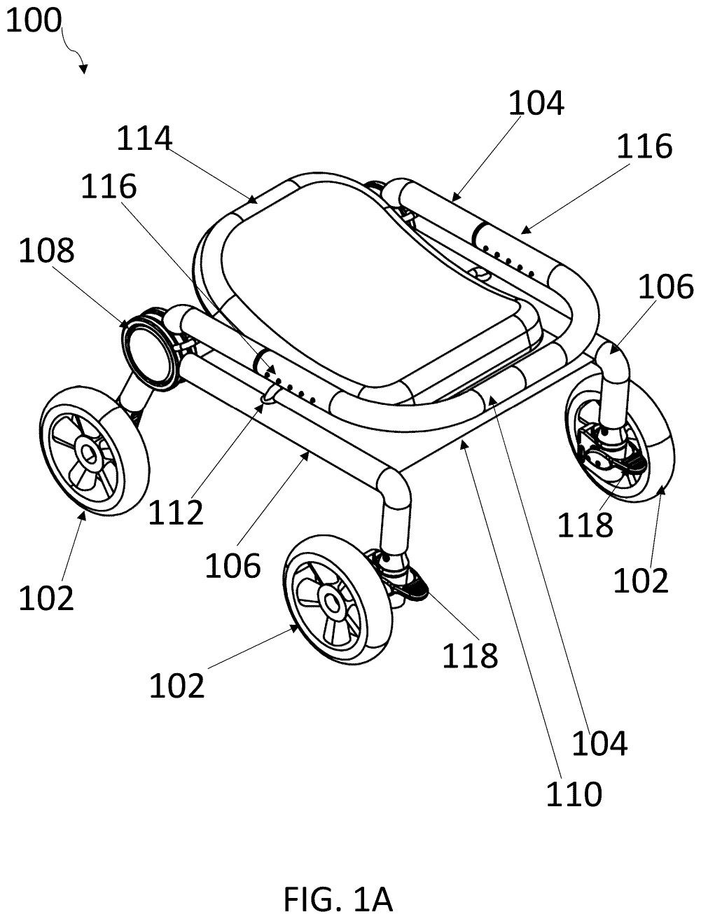

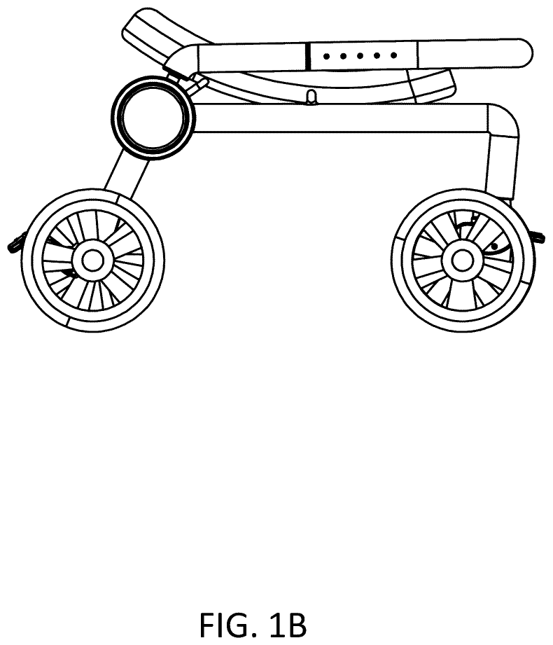

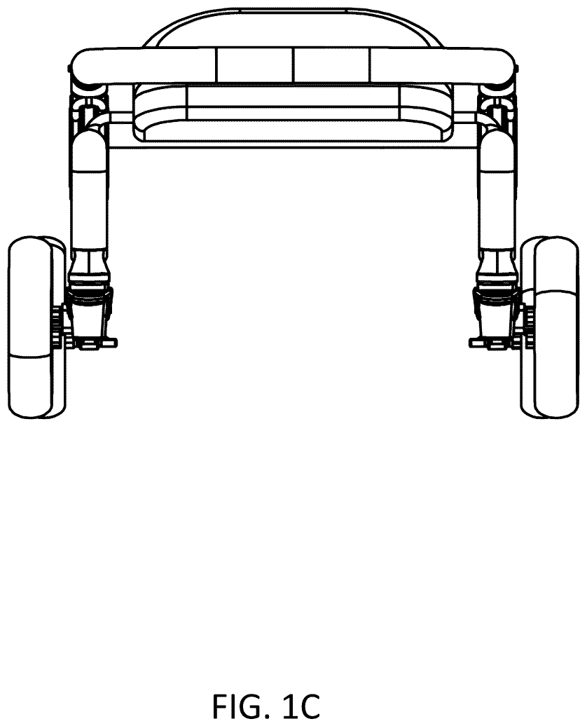

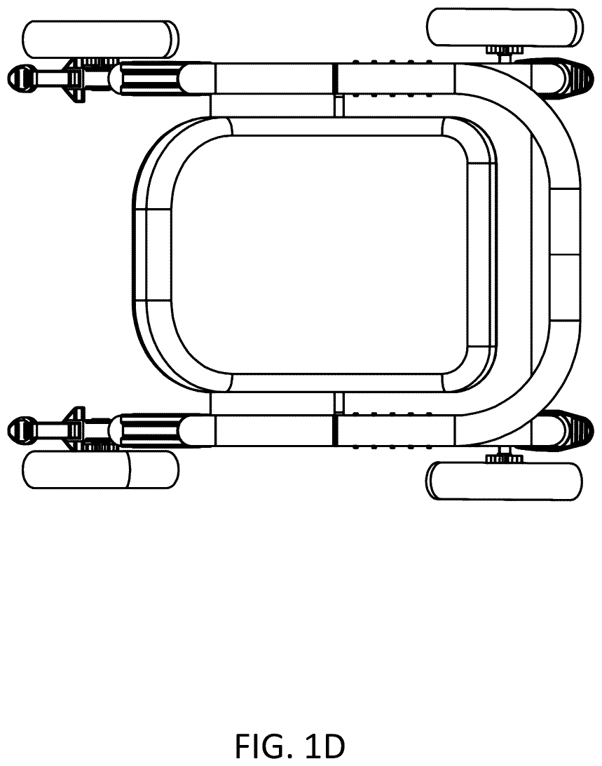

In at least one aspect of the present disclosure, a modular stroller frame is disclosed. In at least one iteration of the present disclosure, as shown in FIG. 1A, the modular stroller frame 100 can include a plurality of wheels 102, a U-shaped support brace 104, and at least two support members 106 adjustably connected to the U-shaped support brace 104. In at least one aspect of the present disclosure, the U-shaped support brace is a unitary piece. The U-shaped support brace may be a combination of two or more components. The at least two support members 106 can be adjustably connected to one or more wheels of the plurality of wheels 102 via an adjustment component 108. Advantageously, this enables the wheels to be replaced as desired (e.g., bigger size, worn out). The modular stroller frame 100 may include a layer of material 110 (e.g., covering) positioned between the at least two support members 106. The layer of material may be of varying sizes and material. Each support member of the at least two support members 106 can receive an attachment component 112 (e.g., fastener) corresponding to a base 114. The base 114 can receive a seat designed to support an infant or toddler. The U-shaped support brace 104 may include one or more adjustable components 116 designed to modify a position of the U-shaped support brace.

In at least one aspect of the present disclosure, a modular stroller including a support brace is disclosed. The support brace may be U-shaped, square shaped, curved, or other similar designs that provide an ergonomic modular stroller. The support brace can be adjustably connected to one or more support members of the modular stroller. Advantageously, the adjustable connection enables repositioning of the support brace and/or the plurality of support members to a desired position. Further, the support brace can be positioned to reduce the overall size and/or footprint of the modular stroller to improve the storage and transportation of the modular stroller. In at least one aspect of the present disclosure, the support brace may include an adjustable handle component. The adjustable handle component may be integrated or removably connected to the support brace. The adjustable handle component can modify a length, height, and/or angle of the handle to a desired height.

In at least one aspect of the present disclosure, a modular stroller including a base is disclosed. The base can be removably attached to one or more support members of the modular stroller. The base is configured to receive a seat. For example, and without limitation, the seat can include a car seat, a toddler seat, a rear-facing seat, a front-facing seat and/or other seats for supporting and transporting an infant or toddler. The base can support seats of varying sizes. The base may include a latch, a harness, or other similar attachment mechanisms to receive a corresponding seat.

In at least one aspect of the present disclosure, a modular stroller including a plurality of support members is disclosed. The plurality of support members may be adjustably connected to a support brace. The plurality of support members may be adjustably connected to a plurality of wheels. The plurality of support members can receive a base designed to support a seat. The plurality of support members can extend away from and/or move toward the support brace. For example, and without limitation, the plurality of support members may move toward the support brace to reduce an overall size of the modular stroller. Advantageously, this improves the ease of storing and transporting the modular stroller. The plurality of support members may include a material that is lightweight and flexible.

In at least one aspect of the present disclosure, a modular stroller including a plurality of wheels is disclosed. The plurality of wheels can be permanently attached to the modular stroller frame. Alternatively, the plurality of wheels may be removably attached to the modular stroller frame. Advantageously, this enables the tires to be swapped as necessary. For example, and without limitation, the wheels may be swapped based on a surface (e.g., cushion wheels for smooth surfaces, shock absorption wheels for rough terrains). The modular stroller frame can further include a wheel braking system. The wheel braking system may include a centralized braking system designed for simultaneously locking of all of the wheels of the plurality of wheels.

In at least one aspect of the present disclosure, a modular stroller frame including a plurality of adjustable components is disclosed. The plurality of adjustable components can connect a plurality of components of the modular stroller frame (e.g., support brace, support member, wheels) and enable repositioning of one or more components. The plurality of adjustable components can be configured to release engage one or more components. For example, and without limitation, a modular stroller frame may include an adjustable connector to releasable engage a wheel of the modular stroller frame. The adjustable connector can engage and release the wheel to enable swapping of the wheel as desired.

In at least one aspect of the present disclosure, the modular stroller frame can further include one or more modular storage compartments and/or accessories. For example, and without limitation, the modular storage compartments and/or accessories may include a detachable diaper bag, an insulated bottle holder, a supplies organizer, a phone holder, and other systems or accessories.

In at least one aspect of the present disclosure, the modular stroller frame can include carbon steel, stainless steel, aluminum alloy, magnesium alloy, plastic-reinforced composites, rubber, plastic, fabric, (e.g., polyester), and other similar materials. In at least one aspect of the present disclosure, a modular stroller frame designed to meet the standards of ASTM F833-21 is disclosed. “Standard Consumer Safety Performance Specification for Carriages and Strollers”—ASTM F833: 021, ASTM International, 2021 is herein incorporated by reference in its entirety. In at least one aspect of the present disclosure, when in the collapsed configuration, the modular stroller frame includes a footprint of about 22 inches by 14 inches by 9 inches. In at least one aspect of the present disclosure, the modular stroller frame includes one or more color-coded components. The color-colored components can indicate proper positioning and functionality of the corresponding components to improve manufacturing and installation. In at least one aspect of the present disclosure, the modular stroller frame is configured to move into a collapsed configuration with one hand of a user. For example, and without limitation, pressure can be applied to the support brace to move the support brace toward a base of the modular stroller frame. As the support brace moves toward the base, the base, the plurality of support members, and/or the plurality of support members can collapse toward the support brace to reduce the size of the modular stroller frame.

In at least one aspect of the present disclosure, each wheel of the plurality of wheels 102 is connected to at least one support member 106 of the frame. The plurality of wheels may be connected via an adjustable component (e.g., ball and socket joint). The modular stroller frame can further include a control device and/or system for controlling the movement of the wheels 118.

In at least one aspect of the present disclosure, the modular stroller frame includes a fastener for securing one or more components. The fastener may include a screw, a bolt, a rivet, a snap fastener, a quick-release pin, a hook and loop fastener, a snap-fit connector, or other similar fasteners. In at least one aspect of the present disclosure, the modular stroller frame may include a joint for enabling the movement of one or more components. The joint may be positioned between one or more support members, the support members and the support brace, and/or the support members and the plurality of wheels. In at least one aspect of the present disclosure, the modular stroller frame includes a wheel locking mechanism. The wheel locking mechanism may include an axel brake, an individual wheel brake, a swivel wheel lock, a cable-actuated brake, a drum brake, a disc brake, and/or a parking brake.

In at least one aspect of the present disclosure, the modular stroller frame is designed for swapping the plurality of wheels. The modular stroller frame can include a device and/or system for releasably engaging the plurality of wheels. For example, and without limitation, the modular stroller frame may include a quick-release axle, a detent pin and groove system, a cam-lock axle and lever, a snap-fit socket, and/or a fork and hub system.

In at least one aspect of the present disclosure, the modular stroller frame can move between a collapsed configuration and an open configuration. When moving from the collapsed configuration to the open configuration, the U-shaped support brace can move away from the plurality of support members to a substantially vertical position. In the open configuration, the U-shaped support member enables users to push the modular stroller frame. Additionally, a base of the modular stroller frame can be accessed to receive a seat for transporting a toddler or infant. In the collapsed configuration, the modular stroller frame can be stored in a container (e.g., backpack). Advantageously, this improves the transportation of the modular stroller frame during travel.

The modular stroller frame 200 can include a frame and a plurality of wheels 202. The frame can include a U-shaped support member 204 and at least two support members 206 adjustably connected to the U-shaped support member 204. The at least two support members 206 can be adjustably connected to one or more wheels of the plurality of wheels 202 via an adjustment component 208. The modular stroller frame may include a layer of material 210 (e.g., covering) positioned between the at least two support members. Each support member of the at least two support members 206 can receive an attachment component 212 (e.g., fastener) from a corresponding base 214. The base 214 can receive a seat designed to support an infant or toddler. The U-shaped support brace 204 may include one or more adjustable components 216 designed to modify a position of the U-shaped support brace.

In at least one aspect of the present disclosure, a modular stroller including a support brace is disclosed. The support brace may be U-shaped, square shaped, curved, or other similar designs that provide an ergonomic modular stroller. The support brace can be adjustably connected to one or more support members of the modular stroller. Advantageously, the adjustable connection enables repositioning of the support brace and/or the plurality of support members to a desired position. Further, the support brace can be positioned to reduce the overall size and/or footprint of the modular stroller to improve the storage and transportation of the modular stroller. In at least one aspect of the present disclosure, the support brace may include an adjustable handle component. The adjustable handle component may be integrated or removably connected to the support brace. The adjustable handle component can modify a length, height, and/or angle of the handle to a desired height.

In at least one aspect of the present disclosure, a modular stroller including a base is disclosed. The base can be removably attached to one or more support members of the modular stroller. The base is configured to receive a seat. For example, and without limitation, the seat can include a car seat, a toddler seat, a rear-facing seat, a front-facing seat and/or other seats for supporting and transporting an infant or toddler. The base can support seats of varying sizes. The base may include a latch, a harness, or other similar attachment mechanisms to receive a corresponding seat.

In at least one aspect of the present disclosure, a modular stroller including a plurality of support members is disclosed. The plurality of support members may be adjustably connected to a support brace. The plurality of support members may be adjustably connected to a plurality of wheels. The plurality of support members can receive a base designed to support a seat. The plurality of support members can extend away from and/or move toward the support brace. For example, and without limitation, the plurality of support members may move toward the support brace to reduce the overall size of the modular stroller. Advantageously, this improves the ease of storing and transporting the modular stroller. The plurality of support members may include a material that is lightweight and flexible.

In at least one aspect of the present disclosure, a modular stroller including a plurality of wheels is disclosed. The plurality of wheels can be permanently attached to the modular stroller frame. Alternatively, the plurality of wheels may be removably attached to the modular stroller frame. Advantageously, this enables the tires to be swapped as necessary. For example, and without limitation, the wheels may be swapped based on a surface (e.g., cushion wheels for smooth surfaces, shock absorption wheels for rough terrains). The modular stroller frame can further include a wheel braking system. The wheel braking system may include a centralized braking system designed for simultaneously locking of all of the wheels of the plurality of wheels.

In at least one aspect of the present disclosure, a modular stroller frame including a plurality of adjustable components is disclosed. The plurality of adjustable components can connect a plurality of components of the modular stroller frame (e.g., support brace, support member, wheels) and enable repositioning of one or more components. The plurality of adjustable components can be configured to release engage one or more components. For example, and without limitation, a modular stroller frame may include an adjustable connector to releasable engage a wheel of the modular stroller frame. The adjustable connector can engage and release the wheel to enable swapping of the wheel as desired.

In at least one aspect of the present disclosure, the modular stroller frame can further include one or more modular storage compartments and/or accessories. For example, and without limitation, the modular storage compartments and/or accessories may include a detachable diaper bag, an insulated bottle holder, a supplies organizer, a phone holder, and other systems or accessories.

In at least one aspect of the present disclosure, the modular stroller frame can include carbon steel, stainless steel, aluminum alloy, magnesium alloy, plastic-reinforced composites, rubber, plastic, fabric, (e.g., polyester), and other similar materials. In at least one aspect of the present disclosure, a modular stroller frame designed to meet the standards of ASTM F833-21 is disclosed. “Standard Consumer Safety Performance Specification for Carriages and Strollers”—ASTM F833: 021, ASTM International, 2021 is herein incorporated by reference in its entirety. In at least one aspect of the present disclosure, when in the collapsed configuration, the modular stroller frame includes a footprint of about 22 inches by 14 inches by 9 inches. In at least one aspect of the present disclosure, the modular stroller frame includes one or more color-coded components. The color-colored components can indicate proper positioning and functionality of the corresponding components to improve manufacturing and installation. In at least one aspect of the present disclosure, the modular stroller frame is configured to move into a collapsed configuration with one hand of a user. For example, and without limitation, pressure can be applied to the support brace to move the support brace toward a base of the modular stroller frame. As the support brace moves toward the base, the base, the plurality of support members, and/or the plurality of support members can collapse toward the support brace to reduce the size of the modular stroller frame.

In at least one aspect of the present disclosure, each wheel of the plurality of wheels is connected to at least one support member of the frame. The plurality of wheels may be connected via an adjustable component (e.g., ball and socket joint). The modular stroller frame further includes an adjustment device for controlling the rotation of the wheels 218.

In at least one aspect of the present disclosure, the modular stroller frame includes a fastener for securing one or more components. The fastener may include a screw, a bolt, a rivet, a snap fastener, a quick-release pin, a hook and loop fastener, a snap-fit connector, or other similar fasteners. In at least one aspect of the present disclosure, the modular stroller frame may include a joint for enabling the movement of one or more components. The joint may include a hinged joint, a telescoping joint, a ball-and-socket joint, a swivel joint, a sliding joint, a pivot joint, a latching joint, and/or a locking joint. In at least one aspect of the present disclosure, the modular stroller frame includes a wheel locking mechanism. The wheel locking mechanism may include an axel brake, an individual wheel brake, a swivel wheel lock, a cable-actuated brake, a drum brake, a disc brake, and/or a parking brake.

In at least one aspect of the present disclosure, the modular stroller frame is designed for swapping the plurality of wheels. The modular stroller frame can include a device and/or system for releasably engaging the plurality of wheels. For example, and without limitation, the modular stroller frame may include a quick-release axle, a detent pin and groove system, a cam-lock axle and lever, a snap-fit socket, and/or a fork and hub system.

The modular stroller frame can move between a collapsed configuration and an open configuration. When moving from the collapsed configuration to the open configuration, the U-shaped support brace can move away from the plurality of support members to a substantially vertical position. In the open configuration, the U-shaped support member enables users to push the modular stroller frame. Additionally, a base of the modular stroller frame can be accessed to receive a seat for transporting a toddler or infant. In the collapsed configuration, the modular stroller frame can be stored in a container (e.g., backpack). Advantageously, this improves the transportation of the modular stroller frame during travel.

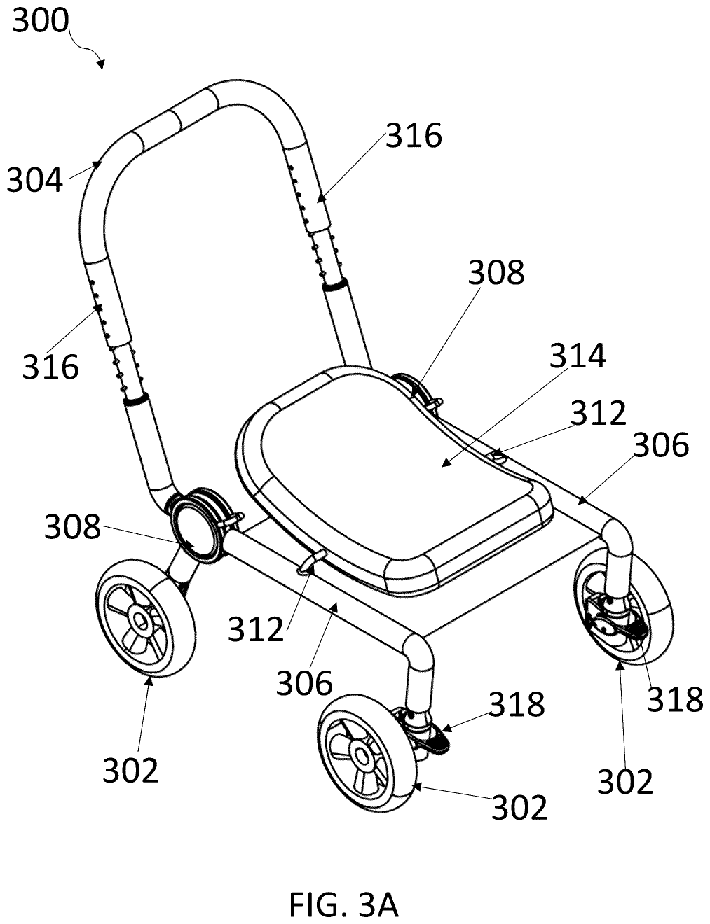

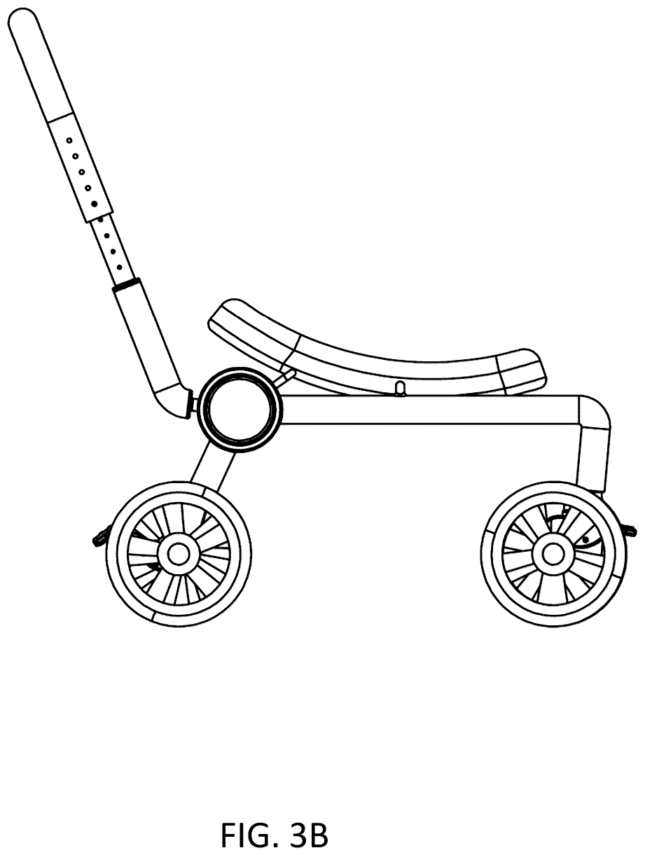

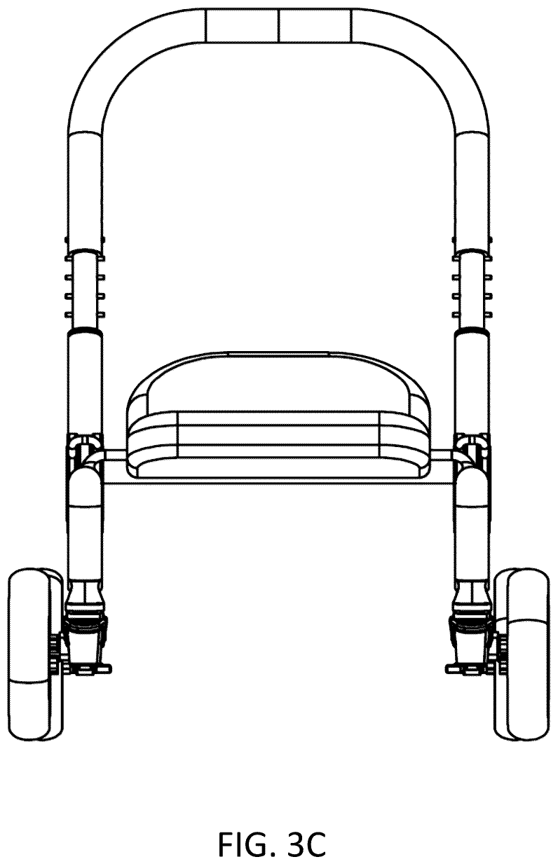

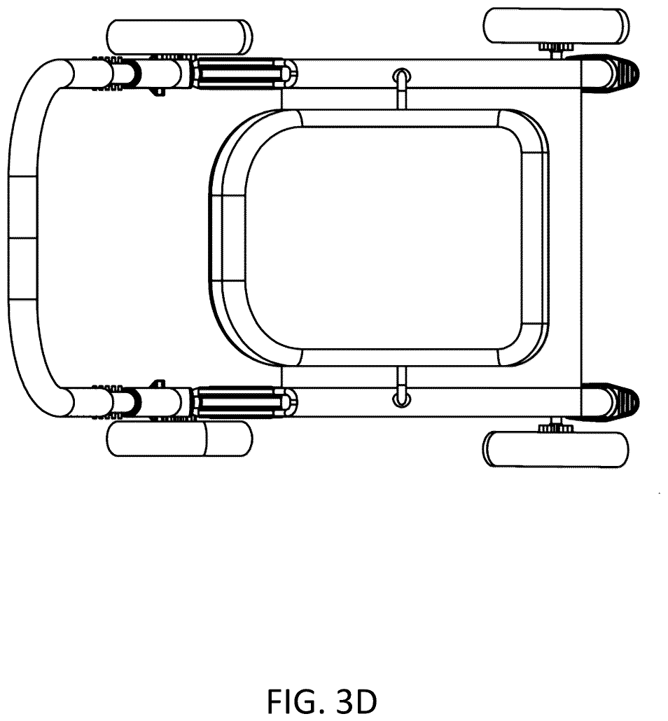

As illustrated in FIGS. 3A-3D, the U-shaped support brace can include at least two adjustment components for extending or shortening a length of the U-shaped support brace. Advantageously, this enables the modular stroller to be customized to a height of a user.

In at least one aspect of the present disclosure, a modular stroller frame is disclosed. For example, and without limitation, as shown in FIG. 3A, the modular stroller frame 300 can include a frame and a plurality of wheels 302. The frame can include a U-shaped support brace 304 and at least two support members 306 adjustably connected to the U-shaped support brace 304. In at least one aspect of the present disclosure, the U-shaped support brace is a unitary piece. The U-shaped support brace may be a combination of two or more components. The at least two support members 306 can be adjustably connected to one or more wheels of the plurality of wheels 302 via an adjustment component 308. Advantageously, this enables the wheels to be replaced as desired (e.g., bigger size, worn out). The modular stroller frame 300 may include a layer of material 310 (e.g., covering) positioned between the at least two support members 306. Each support member of the at least two support members 306 can receive an attachment component 312 (e.g., fastener) from a corresponding base 314. The base 314 can receive releasably engage a seat designed to support an infant and/or toddler. The U-shaped support brace 304 may include one or more adjustable components 316 designed to modify a position of the U-shaped support brace. The one or more adjustable components 316 may include a plurality of slots or holes corresponding to a change in position.

In at least one aspect of the present disclosure, a modular stroller including a support brace is disclosed. The support brace may be U-shaped, square shaped, curved, or other similar designs that provide an ergonomic modular stroller. The support brace can be adjustably connected to one or more support members of the modular stroller. Advantageously, the adjustable connection enables repositioning of the support brace and/or the plurality of support members to a desired position. Further, the support brace can be positioned to reduce the overall size and/or footprint of the modular stroller to improve the storage and transportation of the modular stroller. In at least one aspect of the present disclosure, the support brace may include an adjustable handle component. The adjustable handle component may be integrated or removably connected to the support brace. The adjustable handle component can modify a length, height, and/or angle of the handle to a desired height.

In at least one aspect of the present disclosure, a modular stroller including a base is disclosed. The base can be removably attached to one or more support members of the modular stroller. The base is configured to receive a seat. For example, and without limitation, the seat can include a car seat, a toddler seat, a rear-facing seat, a front-facing seat and/or other seats for supporting and transporting an infant or toddler. The base can support seats of varying sizes. The base may include a latch, a harness, or other similar attachment mechanisms to receive a corresponding seat.

In at least one aspect of the present disclosure, a modular stroller including a plurality of support members is disclosed. The plurality of support members may be adjustably connected to a support brace. The plurality of support members may be adjustably connected to a plurality of wheels. The plurality of support members can receive a base designed to support a seat. The plurality of support members can extend away from and/or move toward the support brace. For example, and without limitation, the plurality of support members may move toward the support brace to reduce the overall size of the modular stroller. Advantageously, this improves the ease of storing and transporting the modular stroller. The plurality of support members may include a material that is lightweight and flexible.

In at least one aspect of the present disclosure, a modular stroller including a plurality of wheels is disclosed. The plurality of wheels can be permanently attached to the modular stroller frame. Alternatively, the plurality of wheels may be removably attached to the modular stroller frame. Advantageously, this enables the tires to be swapped as necessary. For example, and without limitation, the wheels may be swapped based on a surface (e.g., cushion wheels for smooth surfaces, shock absorption wheels for rough terrains). The modular stroller frame can further include a wheel braking system. The wheel braking system may include a centralized braking system designed for simultaneously locking of all of the wheels of the plurality of wheels.

In at least one aspect of the present disclosure, a modular stroller frame including a plurality of adjustable components is disclosed. The plurality of adjustable components can connect a plurality of components of the modular stroller frame (e.g., support brace, support member, wheels) and enable repositioning of one or more components. The plurality of adjustable components can be configured to release engage one or more components. For example, and without limitation, a modular stroller frame may include an adjustable connector to releasable engage a wheel of the modular stroller frame. The adjustable connector can engage and release the wheel to enable swapping of the wheel as desired.

In at least one aspect of the present disclosure, the modular stroller frame can further include one or more modular storage compartments and/or accessories. For example, and without limitation, the modular storage compartments and/or accessories may include a detachable diaper bag, an insulated bottle holder, a supplies organizer, a phone holder, and other systems or accessories.

In at least one aspect of the present disclosure, the modular stroller frame can include carbon steel, stainless steel, aluminum alloy, magnesium alloy, plastic-reinforced composites, rubber, plastic, fabric, (e.g., polyester), and other similar materials. In at least one aspect of the present disclosure, a modular stroller frame designed to meet the standards of ASTM F833-21 is disclosed. “Standard Consumer Safety Performance Specification for Carriages and Strollers”—ASTM F833: 021, ASTM International, 2021 is herein incorporated by reference in its entirety. In at least one aspect of the present disclosure, when in the collapsed configuration, the modular stroller frame includes a footprint of about 22 inches by 14 inches by 9 inches. In at least one aspect of the present disclosure, the modular stroller frame includes one or more color-coded components. The color-colored components can indicate proper positioning and functionality of the corresponding components to improve manufacturing and installation. In at least one aspect of the present disclosure, the modular stroller frame is configured to move into a collapsed configuration with one hand of a user. For example, and without limitation, pressure can be applied to the support brace to move the support brace toward a base of the modular stroller frame. As the support brace moves toward the base, the base, the plurality of support members, and/or the plurality of support members can collapse toward the support brace to reduce the size of the modular stroller frame.

In at least one aspect of the present disclosure, each wheel of the plurality of wheels 302 is connected to at least one support member 306 of the frame. The plurality of wheels may be connected via an adjustable component (e.g., ball and socket joint). The modular stroller frame can further include a control device and/or system for controlling the movement of the wheels 318.

In at least one aspect of the present disclosure, the modular stroller frame includes a fastener for securing one or more components. The fastener may include a screw, a bolt, a rivet, a snap fastener, a quick-release pin, a hook and loop fastener, a snap-fit connector, or other similar fasteners. In at least one aspect of the present disclosure, the modular stroller frame may include a joint for enabling the movement of one or more components. The joint may include a hinged joint, a telescoping joint, a ball-and-socket joint, a swivel joint, a sliding joint, a pivot joint, a latching joint, and/or a locking joint. In at least one aspect of the present disclosure, the modular stroller frame includes a wheel locking mechanism. The wheel locking mechanism may include an axel brake, an individual wheel brake, a swivel wheel lock, a cable-actuated brake, a drum brake, a disc brake, and/or a parking brake.

In at least one aspect of the present disclosure, the modular stroller frame is designed for swapping the plurality of wheels. The modular stroller frame can include a device and/or system for releasably engaging the plurality of wheels. For example, and without limitation, the modular stroller frame may include a quick-release axle, a detent pin and groove system, a cam-lock axle and lever, a snap-fit socket, and/or a fork and hub system.

The modular stroller frame can move between a collapsed configuration and an open configuration. When moving from the collapsed configuration to the open configuration, the U-shaped support brace can move away from the plurality of support members to a substantially vertical position. In the open configuration, the U-shaped support brace enables users to push the modular stroller frame. Additionally, a base of the modular stroller frame can be accessed to receive a seat for transporting a toddler or infant. In the collapsed configuration, the modular stroller frame can be stored in a container (e.g., backpack). Advantageously, this improves the transportation of the modular stroller frame during travel.

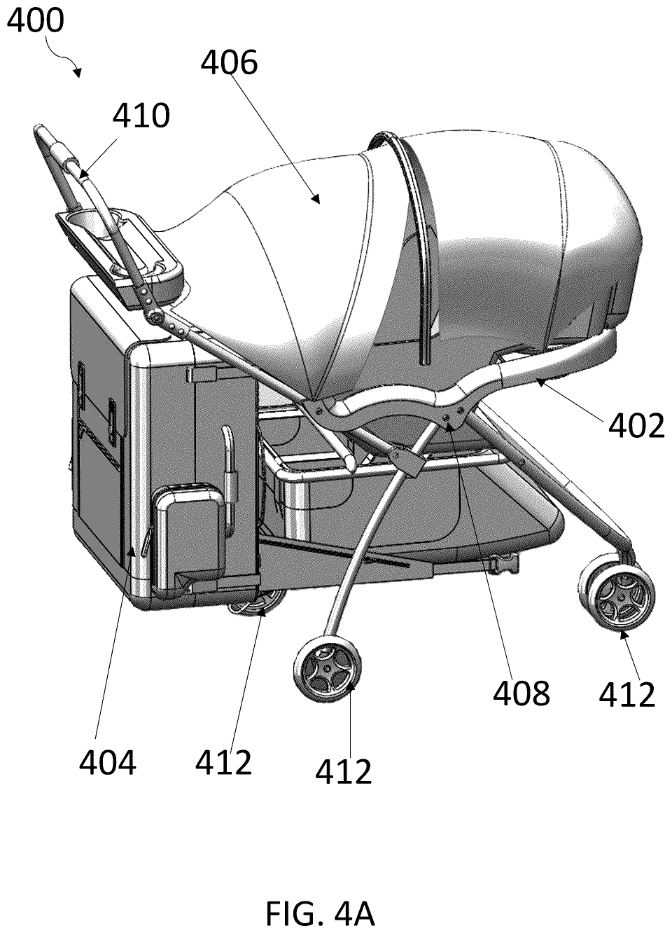

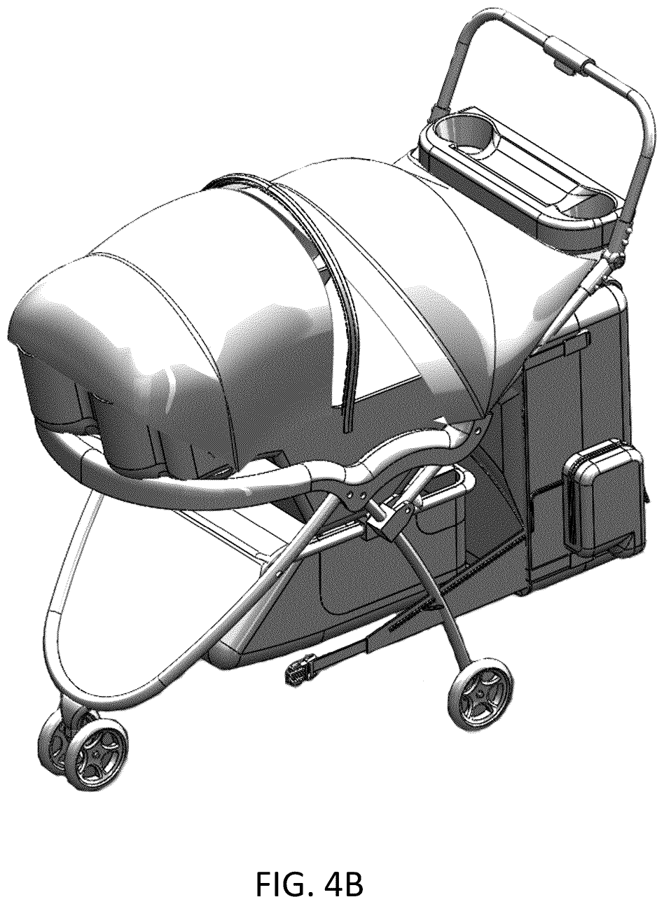

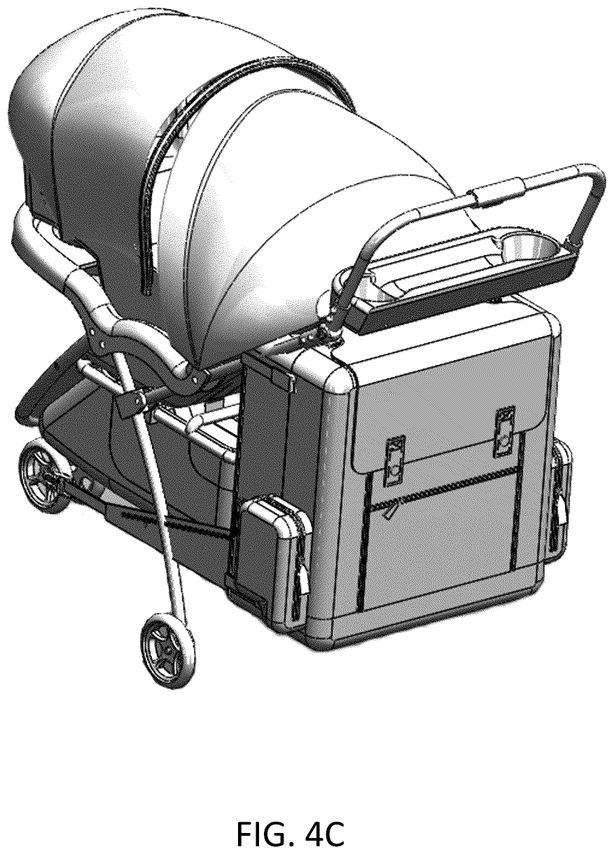

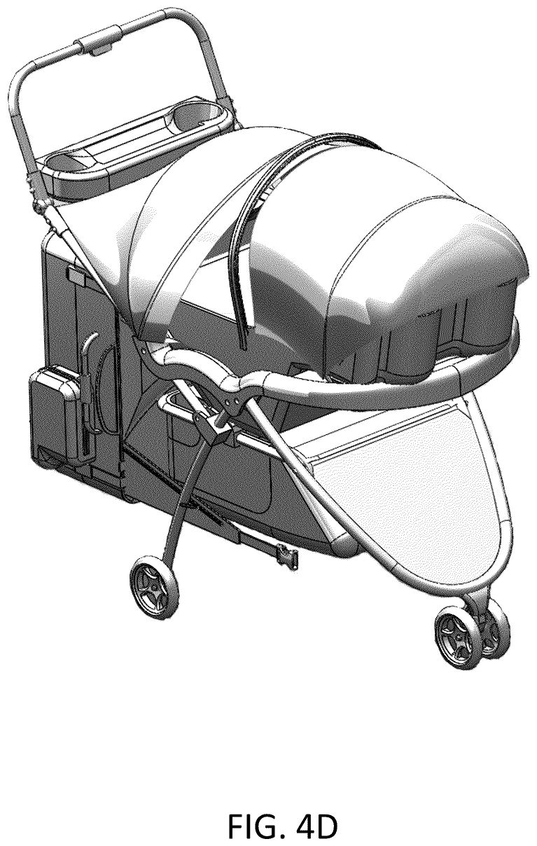

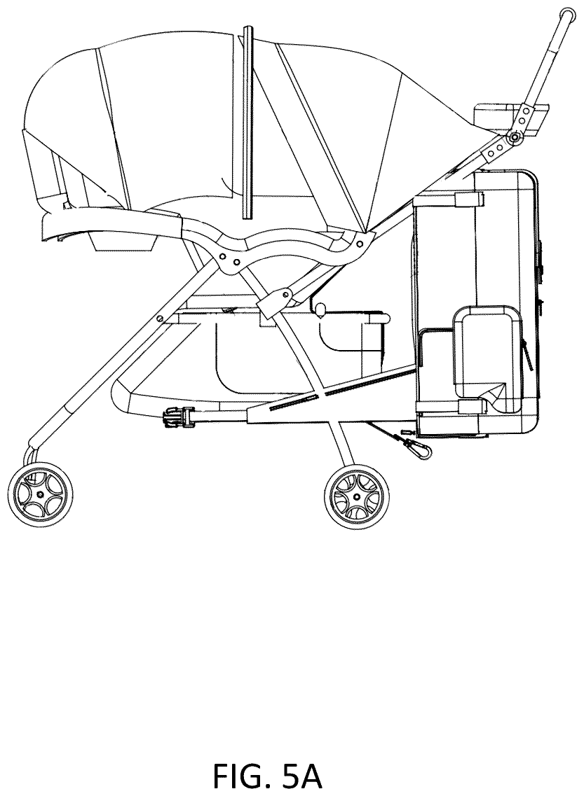

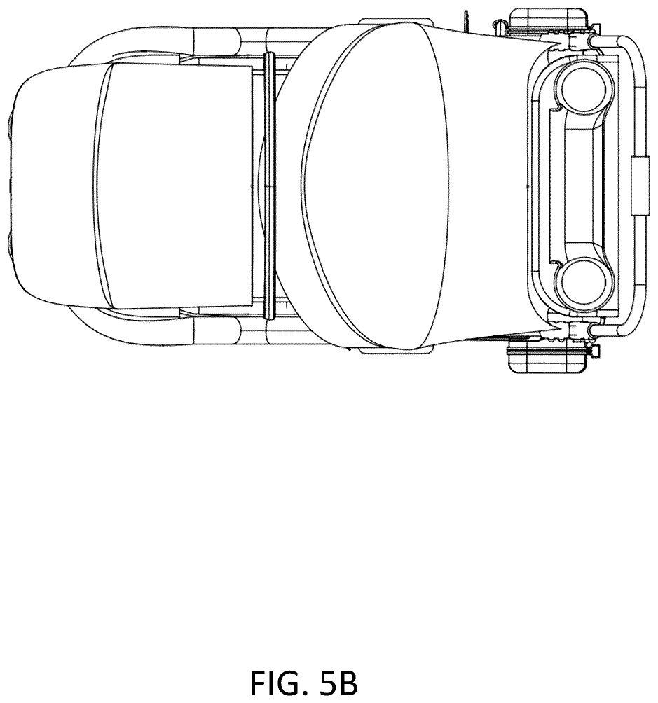

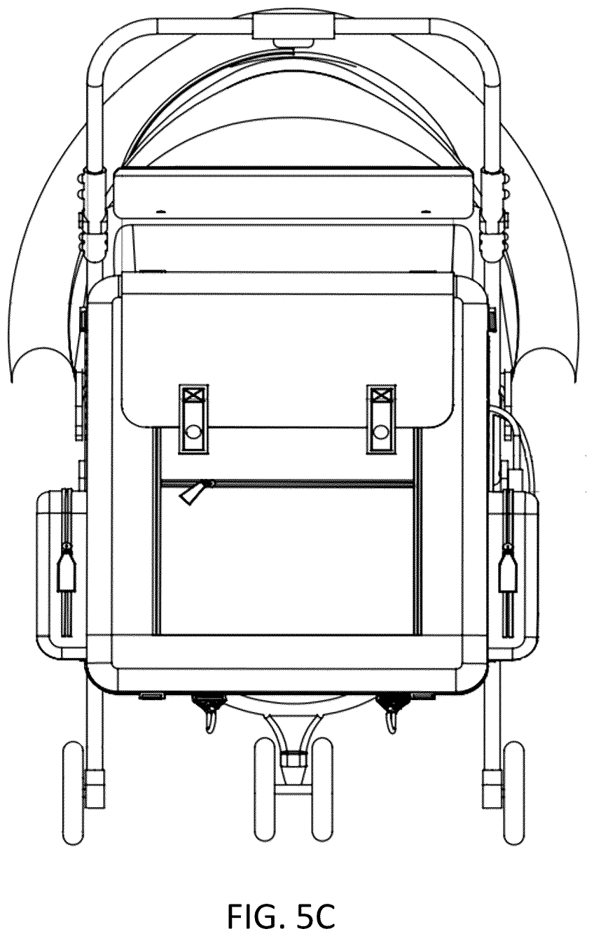

In some embodiments, a modular stroller is disclosed. The modular stroller includes a frame, a backpack, and a seat. The modular stroller is designed to move from an expanded configuration to a stored configuration. In the expanded configuration, the stroller is fully extended as shown in FIGS. 4A-5C. The backpack can reside on a rear portion of the stroller frame. For example, and without limitation, the backpack resides underneath a handle of the stroller frame.

In at least one aspect of the present disclosure, a modular stroller is disclosed. The modular stroller 400 includes a frame 402, a storage container 404, and a cover 406. In at least one iteration, the frame 402 includes a plurality of sliding hinges 408, a handle 410, a plurality of wheels 412, and a plurality of support members. The frame is configured to receive the storage container 404 (e.g., backpack) and at least one seat. The at least one seat can be any seat designed to support an infant or toddler. The frame can further receive the cover 406 for protecting the at least one seat and a seat occupant. The frame handle 410 provides a leverage point for moving the modular stroller. In some embodiments, the frame handle 410 may include a support platform for carrying containers (e.g., beverages). The support platform may be removably attached to the frame handle.

The collapsible frame is designed to move the plurality of wheels toward each other when moving to a collapsed configuration. For example, and without limitation, the collapsible frame includes at least three wheels. At least two wheels are positioned toward a rear of the frame and at least one wheel is positioned toward a front of the frame. The sliding hinges are designed to move up and down the plurality of support members to increase or decrease the distance between the plurality of wheels. The collapsible frame is further operable to receive a carrying component (e.g., bag) attached to a plurality of bottom support members. The collapsible frame is further operable to receive a backpack positioned on a rear of the collapsible frame. In some embodiments, the collapsible frame, when in the collapsed configuration, is designed to fit inside the backpack. The collapsible frame is further designed to receive a plurality of cover components. For example, and without limitation, the collapsible frame can receive a retractable cover designed to cover a body of the modular stroller.

In at least one aspect of the present disclosure, the collapsible stroller frame can include a frame and a plurality of wheels. The frame can include a U-shaped support brace and at least two support members adjustably connected to the U-shaped support brace. In at least one aspect of the present disclosure, the U-shape support brace is a unitary piece. The U-shaped support brace may be a combination of two or more components. The at least two support members can be adjustably connected to one or more wheels of the plurality of wheels via an adjustment component. Advantageously, this enables the wheels to be replaced as desired (e.g., bigger size, worn out). The modular stroller frame may include a layer of material (e.g., covering) positioned between the at least two support members. Each support member of the at least two support members can receive an attachment component (e.g., fastener) from a corresponding seat. The U-shaped support brace may include one or more adjustable components designed to modify a position of the U-shaped support brace. The one or more adjustable components may include a plurality of slots or holes corresponding to a change in position.

In at least one aspect of the present disclosure, each wheel of the plurality of wheels is connected to at least one support member of the frame. The plurality of wheels may be connected via an adjustable component (e.g., ball and socket joint). The modular stroller frame can further include a control device and/or system for controlling the movement of the wheels.

In at least one aspect of the present disclosure, the modular stroller frame includes a fastener for securing one or more components. The fastener may include a screw, a bolt, a rivet, a snap fastener, a quick-release pin, a hook and loop fastener, a snap-fit connector, or other similar fasteners. In at least one aspect of the present disclosure, the modular stroller frame may include a joint for enabling the movement of one or more components. The joint may include a hinged joint, a telescoping joint, a ball-and-socket joint, a swivel joint, a sliding joint, a pivot joint, a latching joint, and/or a locking joint. In at least one aspect of the present disclosure, the modular stroller frame includes a wheel locking mechanism. The wheel locking mechanism may include an axel brake, an individual wheel brake, a swivel wheel lock, a cable-actuated brake, a drum brake, a disc brake, and/or a parking brake.

In at least one aspect of the present disclosure, the modular stroller frame is designed for swapping the plurality of wheels. The modular stroller frame can include a device and/or system for releasably engaging the plurality of wheels. For example, and without limitation, the modular stroller frame may include a quick-release axle, a detent pin and groove system, a cam-lock axle and lever, a snap-fit socket, and/or a fork and hub system.

The modular stroller frame can move between a collapsed configuration and an open configuration. When moving from the collapsed position to the open configuration, the U-shaped support brace can move away from the plurality of support members to a substantially vertical position. In the open configuration, the U-shaped support brace enables users to push the modular stroller frame. Additionally, a set of the modular stroller frame can be accessed to receive a toddler, or infant. In the collapsed configuration, the modular stroller frame can be stored in a container (e.g., backpack). Advantageously, this improves the transportation of the modular stroller frame during travel.

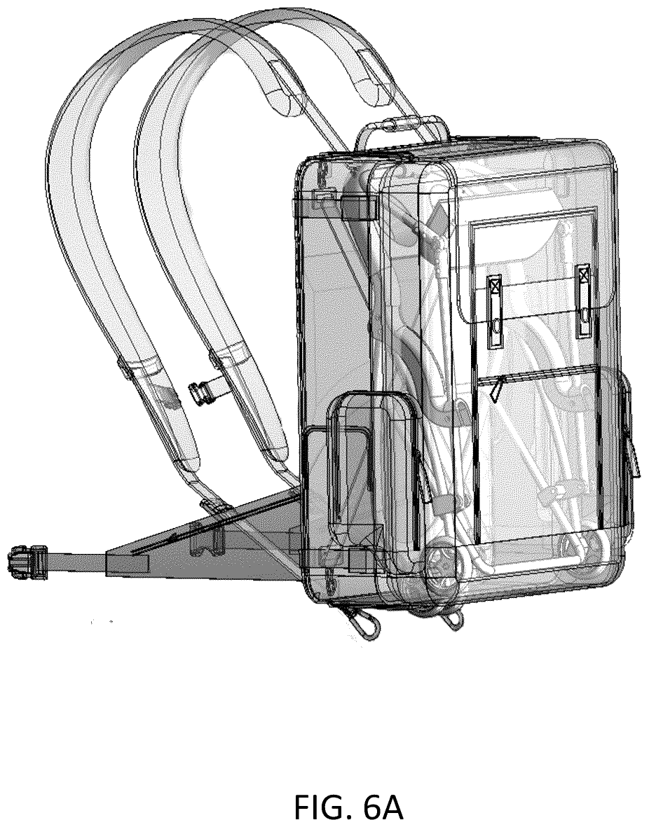

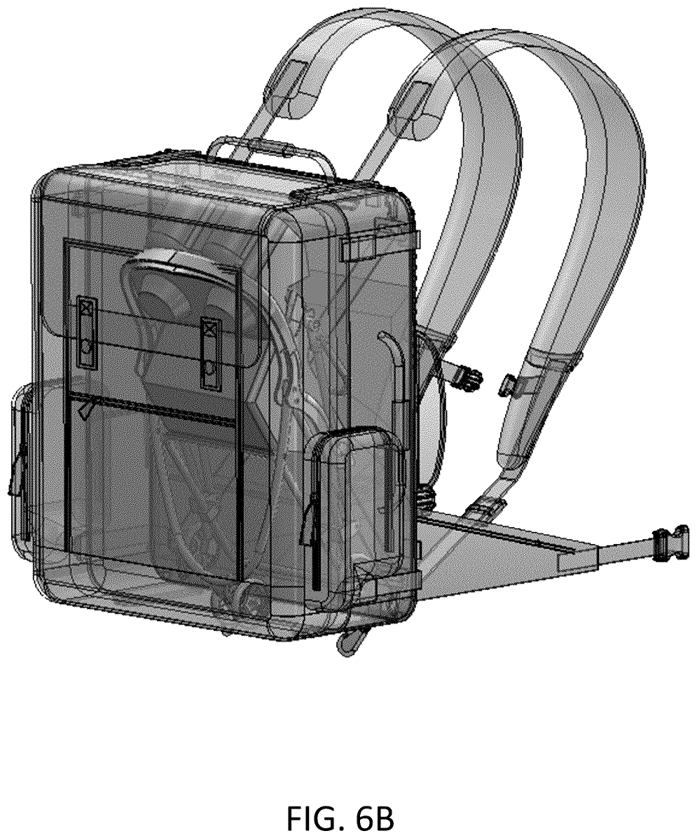

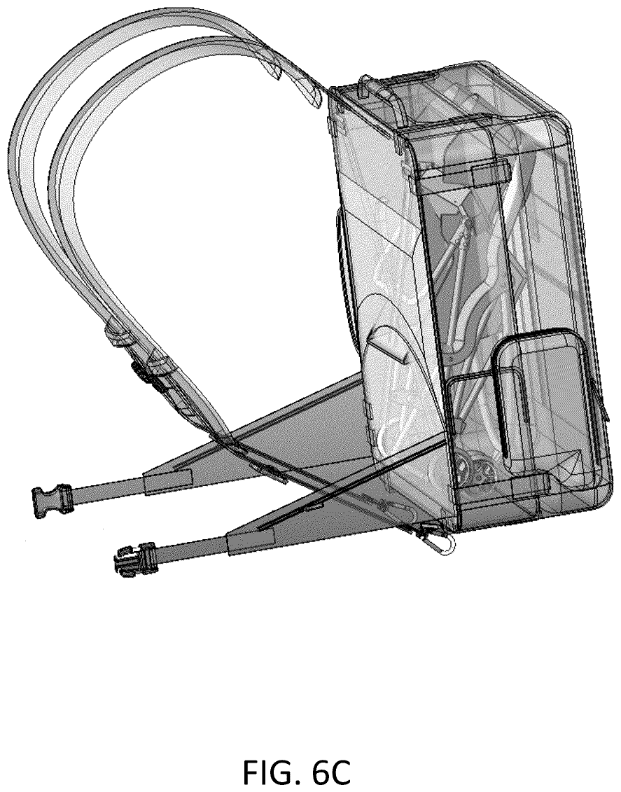

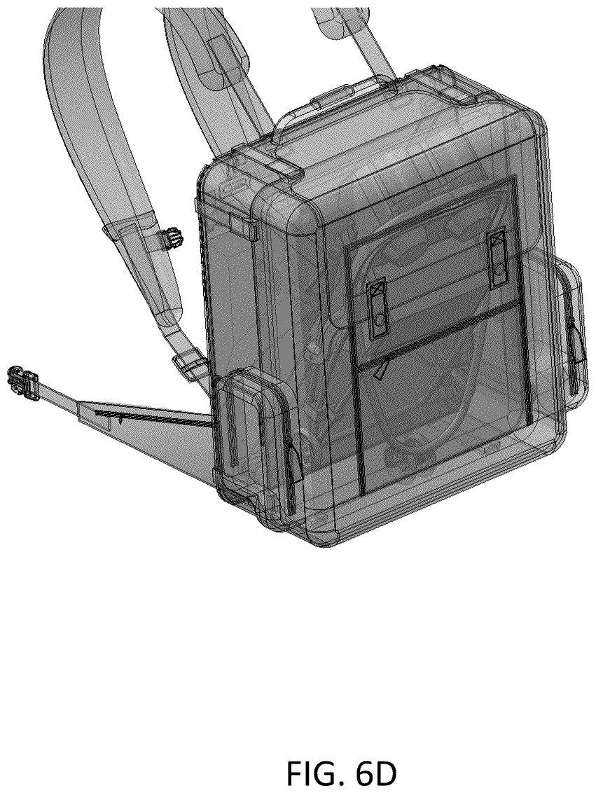

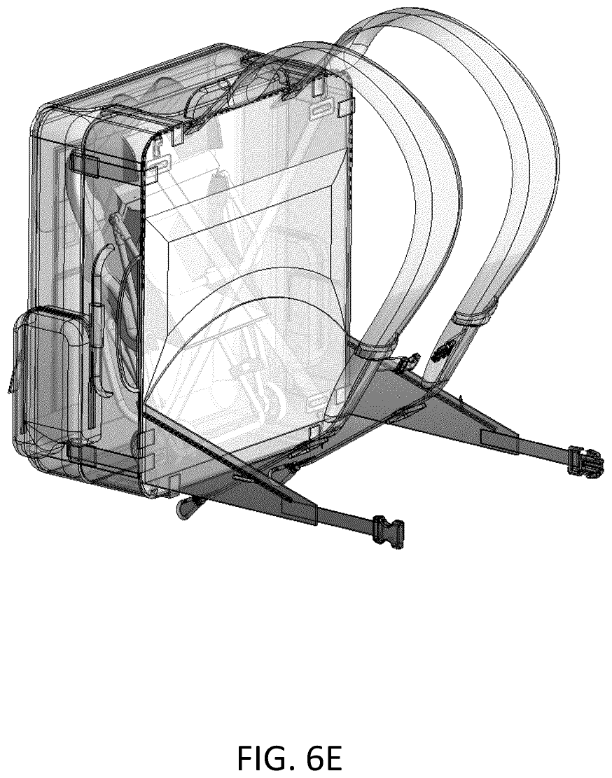

In the stored configuration, as shown in FIGS. 6A to 6E, the modular stroller is configured to be stored in a storage apparatus (e.g., backpack). When transitioning from the expanded configuration to the stored configuration, the stroller frame collapses to reduce the size of the stroller. For example, and without limitation, when moving from the expanded configuration to the stored configuration, the backpack is designed to open a rear panel to receive to the stroller frame as the stroller frame collapses. For further example, and without limitation, the backpack includes a zipper that runs around a portion of the back panel that creates access to the interior of the backpack. For further example, and without limitation, in some embodiments, the cover components of the strollers and the stroller frame are foldable and fit within an interior of the backpack. In some embodiments, the cover components of the stroller and/or the stroller frame collapse into the backpack via a top, bottom, side, front, and/or rear portion of the backpack. In some embodiments, the cover components of the stroller are operable to attach to an exterior surface of the backpack and to provide additional protection. For further example, and without limitation, the cover components may include a material similar to a material of the backpack. In some embodiments, the backpack is completely detachable from the collapsible frame.

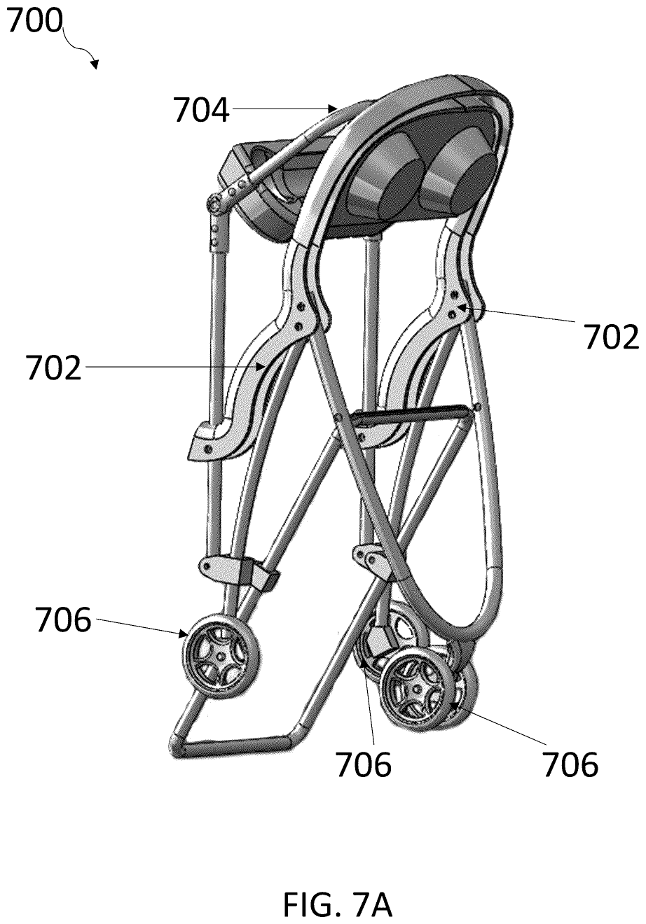

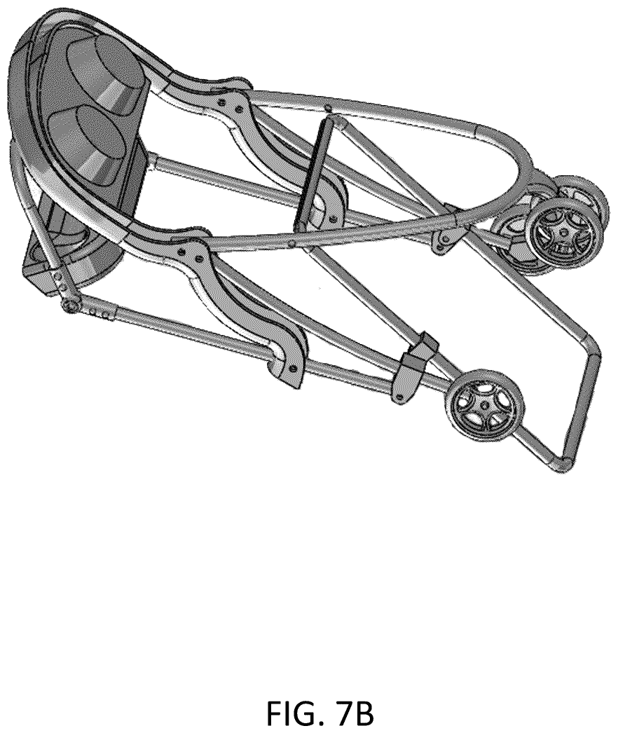

In at least one aspect of the present disclosure, a modular stroller including a collapsible frame is disclosed. For example, and without limitation, as shown in FIGS. 7A and 7B, the collapsible frame 700 includes a plurality of sliding hinges 702, a handle 704, a plurality of wheels 706, and a plurality of support members 708. The collapsible frame is designed to move the plurality of wheels toward each other when moving to a collapsed configuration. For example, and without limitation, the collapsible frame includes at least three wheels. At least two wheels are positioned toward a rear of the frame and at least one wheel is positioned toward a front of the frame. The sliding hinges are designed to move up and down the plurality of support members to increase or decrease the distance between the plurality of wheels. The collapsible frame is further operable to receive a carrying component (e.g., bag) attached to a plurality of bottom support members. The collapsible frame is further operable to receive a backpack positioned on a rear of the collapsible frame. In some embodiments, the collapsible frame, when in the collapsed configuration, is designed to fit inside the backpack. The collapsible frame is further designed to receive a plurality of cover components. For example, and without limitation, the collapsible frame can receive a retractable cover designed to cover a body of the modular stroller.

In at least one aspect of the present disclosure, a modular stroller including a support brace is disclosed. The support brace may be U-shaped, square shaped, curved, or other similar designs that provide an ergonomic modular stroller. The support brace can be adjustably connected to one or more support members of the modular stroller. Advantageously, the adjustable connection enables repositioning of the support brace and/or the plurality of support members to a desired position. Further, the support brace can be positioned to reduce the overall size and/or footprint of the modular stroller to improve the storage and transportation of the modular stroller. In at least one aspect of the present disclosure, the support brace may include an adjustable handle component. The adjustable handle component may be integrated or removably connected to the support brace. The adjustable handle component can modify a length, height, and/or angle of the handle to a desired height.

In at least one aspect of the present disclosure, a modular stroller including a base is disclosed. The base can be removably attached to one or more support members of the modular stroller. The base is configured to receive a seat. For example, and without limitation, the seat can include a car seat, a toddler seat, a rear-facing seat, a front-facing seat and/or other seats for supporting and transporting an infant or toddler. The base can support seats of varying sizes. The base may include a latch, a harness, or other similar attachment mechanisms to receive a corresponding seat.

In at least one aspect of the present disclosure, a modular stroller including a plurality of support members is disclosed. The plurality of support members may be adjustably connected to a support brace. The plurality of support members may be adjustably connected to a plurality of wheels. The plurality of support members can receive a base designed to support a seat. The plurality of support members can extend away from and/or move toward the support brace. For example, and without limitation, the plurality of support members may move toward the support brace to reduce an overall size of the modular stroller. Advantageously, this improves the ease of storing and transporting the modular stroller. The plurality of support members may include a material that is lightweight and flexible.

In at least one aspect of the present disclosure, a modular stroller including a plurality of wheels is disclosed. The plurality of wheels can be permanently attached to the modular stroller frame. Alternatively, the plurality of wheels may be removably attached to the modular stroller frame. Advantageously, this enables the tires to be swapped as necessary. For example, and without limitation, the wheels may be swapped based on a surface (e.g., cushion wheels for smooth surfaces, shock absorption wheels for rough terrains). The modular stroller frame can further include a wheel braking system. The wheel braking system may include a centralized braking system designed for simultaneously locking of all of the wheels of the plurality of wheels.

In at least one aspect of the present disclosure, a modular stroller frame including a plurality of adjustable components is disclosed. The plurality of adjustable components can connect a plurality of components of the modular stroller frame (e.g., support brace, support member, wheels) and enable repositioning of one or more components. The plurality of adjustable components can be configured to release engage one or more components. For example, and without limitation, a modular stroller frame may include an adjustable connector to releasable engage a wheel of the modular stroller frame. The adjustable connector can engage and release the wheel to enable swapping of the wheel as desired.

In at least one aspect of the present disclosure, the modular stroller frame can further include one or more modular storage compartments and/or accessories. For example, and without limitation, the modular storage compartments and/or accessories may include a detachable diaper bag, an insulated bottle holder, a supplies organizer, a phone holder, and other systems or accessories.

In at least one aspect of the present disclosure, the modular stroller frame can include carbon steel, stainless steel, aluminum alloy, magnesium alloy, plastic-reinforced composites, rubber, plastic, fabric, (e.g., polyester), and other similar materials. In at least one aspect of the present disclosure, a modular stroller frame designed to meet the standards of ASTM F833-21 is disclosed. “Standard Consumer Safety Performance Specification for Carriages and Strollers”—ASTM F833: 021, ASTM International, 2021 is herein incorporated by reference in its entirety. In at least one aspect of the present disclosure, when in the collapsed configuration, the modular stroller frame includes a footprint of about 22 inches by 14 inches by 9 inches. In at least one aspect of the present disclosure, the modular stroller frame includes one or more color-coded components. The color-colored components can indicate proper positioning and functionality of the corresponding components to improve manufacturing and installation. In at least one aspect of the present disclosure, the modular stroller frame is configured to move into a collapsed configuration with one hand of a user. For example, and without limitation, pressure can be applied to the support brace to move the support brace toward a base of the modular stroller frame. As the support brace moves toward the base, the base, the plurality of support members, and/or the plurality of support members can collapse toward the support brace to reduce the size of the modular stroller frame.

In some aspects of the present disclosure, the modular stroller is designed to transform into a car seat configuration. For example, and without limitation, the support members and slidable hinges of the stroller frame are adjustably connected (e.g., removably attached) to enable the frame to transition from a stroller configuration to a seat configuration. Each support member can be detached from another support member and repositioned to support a car seat configuration. Advantageously, a cushion used in the stroller configuration can be used as a cushion for the car seat. The backpack is designed to attach to a rear and/or a side of the car seat configuration.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A modular stroller frame comprising:
at least one support brace;
a plurality of support members;
a base; and
a plurality of wheels;
wherein the at least one support brace is adjustably connected to the plurality of support members;
wherein the modular stroller frame is operable to move between a collapsed configuration and an open configuration;
wherein, when moving from the collapsed configuration to the open configuration, the at least one support brace is operable to move away from the plurality of support members.

2. The modular stroller frame of claim 1, wherein the at least one support brace is U-shaped.

3. The modular stroller frame of claim 1, wherein the plurality of wheels is adjustably connected to the plurality of support members.

4. The modular stroller frame of claim 1, wherein the at least one support brace is adjustably connected to the plurality of support members via at least one adjustable component, wherein the at least one support brace is operable to slide along a track of the adjustable component.

5. The modular stroller frame of claim 1, wherein the at least one support brace includes at least one extension component, wherein the at least one extension component is operable to adjust a position of the at least one support brace.

6. The modular stroller frame of claim 1, wherein each support member of the plurality of support members is operable to receive an attachment component corresponding to the base.

7. The modular stroller frame of claim 6, wherein the base is configured to releasably engage a seat.

8. A modular stroller frame comprising:
at least one support brace;
a plurality of support members;
a base; and
a plurality of wheels;
wherein the at least one support brace is adjustably connected to the plurality of support members;
wherein the base is adjustably connected to the plurality of support members;
wherein the modular stroller frame is operable to move between a collapsed configuration and an open configuration;
wherein, when moving from the collapsed configuration to the open configuration, the at least one support brace is operable to move away from the plurality of support members.

9. The modular stroller frame of claim 8, wherein the at least one support brace is U-shaped.

10. The modular stroller frame of claim 8, wherein the plurality of wheels is adjustably connected to the plurality of support members.

11. The modular stroller frame of claim 8, wherein the at least one support brace is adjustably connected to the plurality of support members via at least one adjustable component, wherein the at least one support brace is operable to slide along a track of the adjustable component.

12. The modular stroller frame of claim 8, wherein the at least one support brace includes at least one extension component, wherein the at least one extension component is operable to adjust a position of the at least one support brace.

13. The modular stroller frame of claim 8 further comprising a storage container, wherein, when in the collapsed configuration, the at least one support brace, the plurality of support members, and the plurality of wheels are configured to be positioned inside the storage container.

14. The modular stroller frame of claim 13, wherein the storage container includes a backpack.

15. A modular stroller frame comprising:
at least one support brace;
a plurality of support members;
a base; and
a plurality of wheels;
wherein the at least one support brace is adjustably connected to the plurality of support members;
wherein the base is adjustably connected to the plurality of support members;
wherein the plurality of wheels is adjustably connected to the plurality of support members;
wherein the modular stroller frame is operable to move between a collapsed configuration and an open configuration;
wherein, when moving from the collapsed configuration to the open configuration, the at least one support brace is operable to move away from the plurality of support members.

16. The modular stroller frame of claim 15, wherein the at least one support brace includes at least one extension component, wherein the at least one extension component is operable to adjust a position of the at least one support brace.

17. The modular stroller frame of claim 15 further comprising a storage container, wherein, when in the collapsed configuration, the at least one support brace, the plurality of support members, and the plurality of wheels are configured to be positioned inside the storage container.

18. The modular stroller frame of claim 15, wherein the at least one support brace is U-shaped.

19. The modular stroller frame of claim 15, wherein the at least one support brace is adjustably connected to the plurality of support members via at least two adjustable connectors, wherein the at least two adjustable connectors include at least one of a hinged joint, a telescoping joint, a ball-and-socket joint, a swivel joint, a sliding joint, a pivot joint, a latching joint, and/or a locking joint.

20. The modular stroller frame of claim 15, wherein the base is configured to receive a seat via at least one attachment component, wherein the at least one attachment component includes a latch, a hook and loop fastener, or a harness.
